(19) United States
(12) Patent Application Publication
(10) Pub. No.: US 2011/0253014 A1
(43) Pub. Date: Oct. 20, 2011

(54) METHOD FOR GRINDING NON-CONDUCTIVE MATERIAL

(76) Inventor: Nikolay Fyodorovich GLUKHAREV, SaintPetersburg (RU)

(21) Appl. No.: 13/171,876

(22) Filed: Jun. 29, 2011

Related U.S. Application Data
(63) Continuation-in-part of application No. PCT/RU2010/000392, filed on Jul. 13, 2010.

(30) Foreign Application Priority Data
Jul. 13, 2009 (RU) 2009126511

(51) Int. Cl. C04B 20/00; B02C 19/00

(52) U.S. Cl. 106/819; 241/25

(57) ABSTRACT

The present invention relates to a method for grinding a material, for example, cement or cement additive. The method according to the present invention includes at least one step of mechanical grinding the said material in a grinding apparatus, wherein grinding apparatus comprises grinding bodies, wherein the method further includes a step of neutralizing a debris-layer formed at the pre-surface layer of the grinding bodies by using in combination, in any order, simultaneously or sequentially, the following operations: a) applying electric potential to the grinding bodies in the said at least one grinding step, and b) applying a surfactant to the said non-conductive material in the said at least one grinding step, wherein the amount of surfactant is from 50% to 100% of the normative amount.

The method provides reduction in surfactant consumption, increase of the equipment productivity, reduction of energy consumption and improvement of the wear resistance of the grinding bodies as well as production of cement with the enhanced flow index.

### CROSS-REFERENCE TO RELATED APPLICATION

This application claims the benefits from the International Application PCT/RU2010/000392 filed on Jul. 13, 2010 and claiming priority from RU 2009126511 of Jul. 13, 2009. The content of these applications is hereby incorporated by reference in its entirety.

### FIELD OF THE INVENTION

The present invention relates to a method for grinding a non-conductive material such as cement and cement additive, and can be used in manufacture of construction materials and other applications.

### BACKGROUND OF THE INVENTION

A method for cement production including a step of milling of cement clinker and cement additive in a ball mill is disclosed wherein the specific surface area of the milled cement clinker is 3,500-5,000 cm²/g (see, for example, Butt. Y. M. Technologies of binding materials. Stroyizdat. Moscow, 1965, p. 383-401).

Various techniques for the intensification of milling processes and reduction of strength of solids along with enhancing their ability for deformation and disintegration are well known in the art. One of traditional methods to reduce the free surface energy of a solid includes the use of surfactants.

Thus, SU 1457999 discloses a method for intensification of grinding process wherein a step of clinker milling is performed with preliminary screening of the clinker into fractions having large and small particles, applying to each fraction a surfactant and separate milling of fractions in ball mills. The use of a surfactant reduces the strength of particles having the size of 7 mm and less, by 35%, and the strength of particles having the size of less than 7 mm, by 15%. As a result, the productivity of milling apparatuses significantly increases. The drawback of this method is that the surfactant is a consumable agent that increases costs of the production process.

Surfactants have been widely used as process intensifiers for cement milling during the last 75 years. Typically, anion active surfactants, such as triethanolamine, are used for cement milling. There are different views on the mechanism of action of surfactants, so according to one approach, surfactants have a “wedging” effect and contribute to the disintegration of a particle. According to another approach, the surfactant molecules neutralize electrical charges of positive polarity, formed during the cement milling.

Alternative methods of enhancing milling processes are developed.

Thus, EA3853, publ. Oct. 30, 2003 discloses a method for weakening the crystal structure of materials which can be used in cement manufacturing industry. This method involves exposure of the said material to pulsed sign-variable gradient magnetic field). Similarly, RU 2273611, publ. Apr. 4, 2006, discloses a method for producing a cement or an additive, including grinding of a cement clinker and/or an cement additive in a roller press mill with subsequent milling the cement clinker and/or cement additive, wherein prior to the milling step, the cement or additive is treated by exposure to pulsed variable electromagnetic field with a strength 10⁵-10⁹ A/m and pulse duration (1-10)·10⁻² s. The method provides grinding the cement in the roller press mill to the particle size of 100-1000 μm, wherein the subsequent milling of a clinker and/or an additive reduces the particles' size to 10-80 μkm).

Another approach is disclosed in U.S. Pat. No. 6,367,722, publ. Apr. 9, 2002, wherein a method for grinding non-conductive materials includes mechanical grinding of material to form an electrostatic charge on the particles, wherein, according to the method, the electrostatic charge is neutralized at the step of grinding by applying electric potential sufficient to create a corona discharge.

The method disclosed in U.S. Pat. No. 6,367,722 is aimed at reducing the particle size and facilitating separation of useful fractions. However, the known method can be used to improve the characteristics of grinding apparatuses having productivity that is not higher than 60 t/h. When the known method is useful for mills with low throughput, in case of higher productivity, the effectiveness of the known method is reduced that causes the necessity of developing new effective approaches to intensification of grinding processes.

### BRIEF SUMMARY OF THE INVENTION

The object of the present invention is to reduce the consumption of surfactants while maintaining or increasing the productivity of milling apparatuses for large-scale production to reduce the production and energy costs and provide the environment friendly grinding process.

Another object of the present invention is to increase the quality of milling and flow index of a product, including such as cement and other construction materials. These and other objects of the present invention are achieved by providing a method for grinding a non-conductive material, the method comprising at least one step of mechanical grinding in a grinding apparatus with grinding bodies, wherein the said non-conductive material is treated with a surfactant, wherein the amount of surfactant is 50% to 100% of a normative amount for the same type of material and wherein the step of grinding in a grinding apparatus is carried out simultaneously with application of electric potential to the grinding bodies to neutralize debris layer on the grinding bodies. An additional positive technical effect of the claimed method is polygonization of the pre-surface layer of grinding bodies that result in significant increase of the strength of the grinding bodies.

In the present specification, the term “debris layer” refers to a positively charged pre-surface layer that is formed by dislocations of the crystal structure of the metal of the grinding bodies. It is known that when the deformation of any material including metals occurs, the “sources of dislocation” start to work. These are linear defects that provide the shift of one part of the metal towards another. The dislocations find their way to the metal surface producing the crust, the so called “debris layer” that prevents the way out for other dislocations. The micro-cracks arise under this “crust” that lead to the progress of the defects and as a result to the destruction of a part.

Until recently the research directed at intensification of grinding processes was generally limited by studies focusing on the processes occurring in the particles that undergo grinding. According to a traditional approach, pretreatment of a material with surfactants decreases the surface tension in the particles of a material being ground, such as crystals of cement clinker and/or cement additives, and facilitates their grinding, for example, in a rotating ball mill. According to another approach, the introduction of surfactant contributes to the neutralization of electrostatic charges in the material being ground, that eliminates balling and aggregation of ground particles and increases the productivity of a milling apparatus. The possible support for such a mechanism can be found in Medgar L. Marceau, Ann M. Caffero, “Data Analysis of Electrostatic Charge in a Finish Ball Mill”, Portland Cement Association, Research & Development Information, Serial No. 2855, 2005, which describes studies relating to generation of electrostatic charge in the process of cement milling and the role of a liquid intensifier, such as ethylene glycol, in the grinding process. The studies have shown that the electric charge in a flow of fresh cement ground using ethylene glycol-based surfactant was at the level of −0.46 kV, while the electric charge of a cement ground without surfactants was at the level of +5 kV.

However, in some of grinders, such as roller-press mill, the surfactants cannot be used because it is impossible to distribute the surfactant uniformly in a material being ground that creates additional difficulties and leads to the necessity of looking for alternative ways of milling intensification.

The inventors of the present invention have carried out a thorough research to study the influence of electrostatic charge on the processes involved in material grinding and particularly on the processes that occur in the debris layer. While until now the intensification methods were divided into two groups based on whether the action was directed on the material being processed (for example by irrigation with surfactants) or on the grinding bodies (e.g. by electro physical or other ways) was used, the investigation carried out by the inventor of the present invention was aimed at studying the processes that occur on the interface between the material being ground and pre-surface layer of grinding bodies, with account to the interaction of the two phases.

In particular, the processes were investigated that occurred in the debris layer formed by dislocations of crystal structure of the grinding bodies as a result of their impingement and effect of the ground material during grinding.

The investigation have shown that if the electric potential is applied to the surface of the grinding bodies while milling the material pretreated with a surfactant, the neutralization of “debris layer” in grinding body occurs, that facilitates the elimination of its surface positive charge and provides the interaction of new portions of a material with the neutralized surface of the grinding body and as a result, the positive charges drain from the material being ground is provided, and the grinding apparatus productivity is increased much higher than while these methods are used separately, in other words, a synergistic effect was shown.

The similar effect can be observed when these techniques are combined in two-step grinding process, i.e. when (a) applying electric potential in grinding step in a roller press mill where the use of surfactants is impossible and (b) using surfactants, possibly in combination with potential in the milling step in a ball mill. Additionally, the achievement of the neutral charge of debris layer is important for technical effect to be achieved, wherein the process can include the using of a potential at least on one step and surfactants at least on one step.

The further investigations performed by the inventor of the present invention already on the industrial scale have shown that the combined use of surfactants and electric potential as described herein makes possible to achieve the technical effect providing a substantial decrease of the surfactants consumption or almost full elimination and therefore, reduction of production costs while maintaining or increasing the productivity and grinding quality of materials, such as cement and other construction materials.

Thus, it was proved experimentally that despite the traditional approach to the role of surfactants, the surfactants can act as an antistatic agent that distributes in the bulk of material within the milling apparatus and provides reduction of the level of positive polar electrostatic charges generated on the material surface during its mechanical processing. The process further involves neutralization of the debris-layer of the grinding bodies by means of electrostatic potential being applied to the contacting surface. This provides the additional drain of the positive charge to the surface of the ground material while the surface of the grinding bodies itself gets an extra-strength in this process. The results obtained by the inventor of the present invention in the course of the research served to develop a novel method which successfully combined these two techniques with the results that exceed the expected rate of quality.

As a result of the experimental data and production tests, the inventor of the present invention succeeded to develop a method, described in more detail hereinafter with reference to the attached figures and examples of embodiments, which are illustrative and not limiting the scope of the present invention, which is defined in the attached claims.

### BRIEF DESCRIPTION OF DRAWINGS

FIG. 1 schematically presents one of the embodiments of the present invention by the example of the production line for cement with a combined grinding.

FIG. 2 schematically presents one of the embodiments of the present invention by the example of (a) closed grinding cycle in a ball mill with a separator, and (b) open grinding cycle in a ball mill.

FIG. 3 presents a diagram illustrating the mechanism of a combined action of electric potential and surfactant according to the method proposed in the present invention.

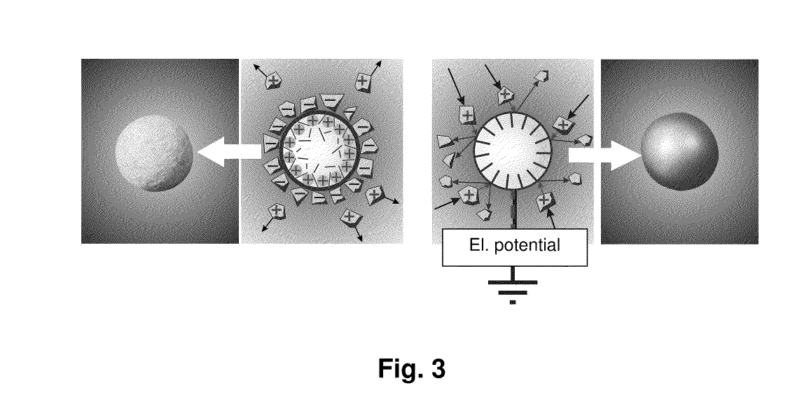

### DETAILED DESCRIPTION OF THE INVENTION

In one embodiment, the present invention provides a method for grinding a non-conductive material in a grinding apparatus with grinding bodies having productivity of about 60 tons per hour and higher, the method including at least one step of mechanical grinding the material, wherein the method further includes a step of neutralizing a debris layer formed at the pre-surface layer of the grinding bodies by using in combination, in any order, simultaneously or sequentially, the following operations:

a) applying electric potential application to the grinding bodies in the said at least one grinding step; and

b) applying a surfactant to the said non-conductive material in the said at least one grinding step, wherein the amount of surfactant is from 50% to 100% of normative amount.

According to this embodiment, the method is especially effective when used in grinding apparatus having productivity of about 60 tons per hour and higher, preferably about 100-110 tons per hour and higher. The use of this method decreases the surfactant consumption up to 50% of normative amount and less while maintaining or increasing the overall equipment productivity by from 8 to 16% of initial productivity. The amount of surfactant can be selected from the following intervals: 50-60%, 60-70%, 70-80%, 80-90%, 90-100%, 50-70%, 50-80%, 50-90%, 50-100%.

In another embodiment, the method for grinding a material is the most effective in the processing in grinding apparatus with grinding bodies having productivity of up to 100 tons per hour, preferably up to 60 tons per hour and less, the method including at least one step of mechanical grinding the material, wherein the method further includes a step of neutralizing a debris layer formed at the pre-surface layer of the grinding bodies by using in combination, in any order, simultaneously or sequentially, the following operations: a) applying electric potential to the grinding bodies in the said at least one grinding step; and b) applying a surfactant to the said non-conductive material in the said at least one grinding step, wherein the amount of surfactant is from 0% to 50% of normative amount, preferably from 10 to 50%. Alternatively, the amount of surfactant can be selected from the following intervals: 0-10%, 10-20%, 20-30%, 30-40%, 40-50%, 10-30%, 10-40%, 10-50%.

The said embodiment is especially effective when used in grinding apparatus having productivity of up to 60 tons per hour. The use of this method in the apparatus with the productivity less than 60 tons per hour helps to decrease the surfactant consumption to 0% while maintaining the overall productivity of the equipment and milling quality level.

According to the Invention, any suitable apparatus can be used as a grinding apparatus, such as a rotating ball mill with grinding balls, vertical roller mill, roller press mill.

According to one embodiment, a grinding method comprises one-step grinding in a ball mill or roller press mill. According to another embodiment, a grinding method comprises a step of pre-grinding in a roller press mill and a step of subsequent milling in a rotating ball mill.

According to one-step grinding method, a surfactant can be applied to material under grinding before the material is fed to a grinding apparatus.

According to the embodiment of the present invention relating to two-step grinding, a surfactant is applied to a material under treatment after roller press mill before feeding to the mill.

A grinding method according to the invention is useful for the production of a wide range of cements including Portland cement, pozzolan Portland cement, slag cement, sulfate-resistant Portland cement and other types of cement. The method is applicable also for the production of hydraulically active mineral additives, including anthropogenic ones produced out of the clinker of the blast-furnace or non-ferrous metallurgy, as well as from the slag waste of the fuel production. According to the invention, a material which can be milled is selected from cement clinker and other materials.

In one embodiment, the applied electric potential is from 70 to 170 V, preferably from 80 to 150 V.

In one embodiment, the electric potential is applied to the surface of grinding bodies in such a way so as to initiate neutralization of the debris layer in the pre-surface layer of a grinding body.

In one embodiment, prior to feeding a particulate material to a ball mill, the particles are treated with surfactant in amount from 50 to 100%, preferably from 60 to 90%, more preferable from 70 to 80% of normative amount. In this embodiment, the productivity of a grinding apparatus can be more than 100-250 t/h, preferably 100-110 t/h. Alternatively, the amount of surfactant can be selected from the following intervals: 50-60%, 60-70%, 70-80%, 80-90%, 90-100%.

According to the present invention, the normative amount of surfactant is determined in accordance with the standard specification, technical conditions, regulations or similar document that is effective for the selected type of cement.

Typically, the normative amount is about 0.01-0.03% wt. of surfactant based on the weight of a material being ground.

Table 1 shows the normative amounts for the most frequently used surfactants. For low-grade cements the most economically preferable are by-products of petrochemical industry, for instance synthetic fatty acids (SFA), vat residua thereof. For highly graded cement the grinding intensifiers used are: organic mono- and polyatomic alcohols, such as alkanolamines, for example, triethanolamine (TEA), triisopropanolamine (e.g., CBA®, produced by GRACE, US), triisopropanolamine mixed with tetrahydroxyethylethylendiamine (“THEED”), ethylene glycol, diethylene glycol (DEG) and mixtures thereof with polyglycerol alcohols, lower fatty acids and sulfonated lignin; unsaturated aliphatic acids and amines, salts of aliphatic C3 acids and amines, and alcohols and amides thereof.

| | Dosage, % of the |
|---|---|
| Grinding intensifier | clinker weight |
| Triethanolamine | 0.025-0.05% wt. |
| Triisopropanolamine, (CBA ®) | 0.005-0.03% wt. |
| | 0.02-0.06% wt. |
| | 0.1-0.2% wt. |
| N,N-bis(2-hydroxyethyl)-2- propanolamine, | 0.01-0.05% wt. for cements |
| (HEA2 ®) | of I and II grade |
| | 0.04-0.08% wt. for cements |
| | of III grade |
| Diethylene glycol (DEG) | 0.04% to 0.06% wt. |
| Polyoxyalkylated amines | 0.2-0.3 kg/t for cement |
| CHRYSO ® Cem Adm3 | |
| Polyethylenglycolmethylmethacrylate | 0.1-0.5 kg/t for Portland |
| (MA.G.A./C ®, Mapei, Italy) | cement |

In one embodiment, the surfactant is an anion active substance. Anion active surfactants are compounds that dissociate in aqueous solutions to form anions (negatively charged ions), providing their surface activity.

According to the invention, the surfactant can be selected from a group consisting of triethanolamine, triisopropanolamine, water solutions of the aminacetates, carboxylic acids and salts thereof (soups), alkyl sulfates (sulfoetheres), alkyl sulfonates, alkyl aryl sulfonates, etc.

In one embodiment, the electric potential is applied to the milling shafts surface of the roller press mill. Additionally, grinding in a roller press mill is carried out to obtain particles having specific surface of 160-250 m²/kg, preferably 190-220 m²/kg.

In one embodiment, the electric potential is applied to the surface of grinding bodies in the ball mill. In this embodiment, the grinding is carried out to obtain cement particles having specific surface of 280-500 m²/kg.

In one embodiment, grinding bodies are made of metal of metal alloy.

In another aspect, the present invention provides a cement or a cement additive produced by a method according to the present invention, wherein the said cement or cement additive is characterized by the flow index that is improved not less than by 40% in comparison with the normative value. For example, in case the normative flow index (the so-called Pack Set Index) of a cement produced by traditional grinding process is 15, the cement milled according to the present invention has Pack Set equal to 6 to 8 (see, e.g. ASTM C1565-09 Standard Test Method for Determination of Pack-Set Index of Portland Cement).

The present invention also provides a method for improvement of a wear resistance of the grinding bodies during grinding of non-conductive material in a mechanical grinding apparatus with grinding bodies, the said method comprising treatment of the said non-conductive material with a surfactant in amount of 50% to 100% based on the normative amount, and grinding with simultaneous application of the electric potential to the grinding bodies, as described in the present invention.

The present invention also provides a method for enhancing the flow index of a product obtained by grinding a non-conductive material in a mechanical grinding apparatus with grinding bodies, the method comprising a step of treating the said material with a surfactant in amount of 50% to 100% of the normative amount, and a step of grinding the pre-treated material combined with application of electric potential to the grinding bodies in a way described in the present invention.

In one embodiment, the electric potential is supplied using electric generator of not more than 0.1 kW power is used.

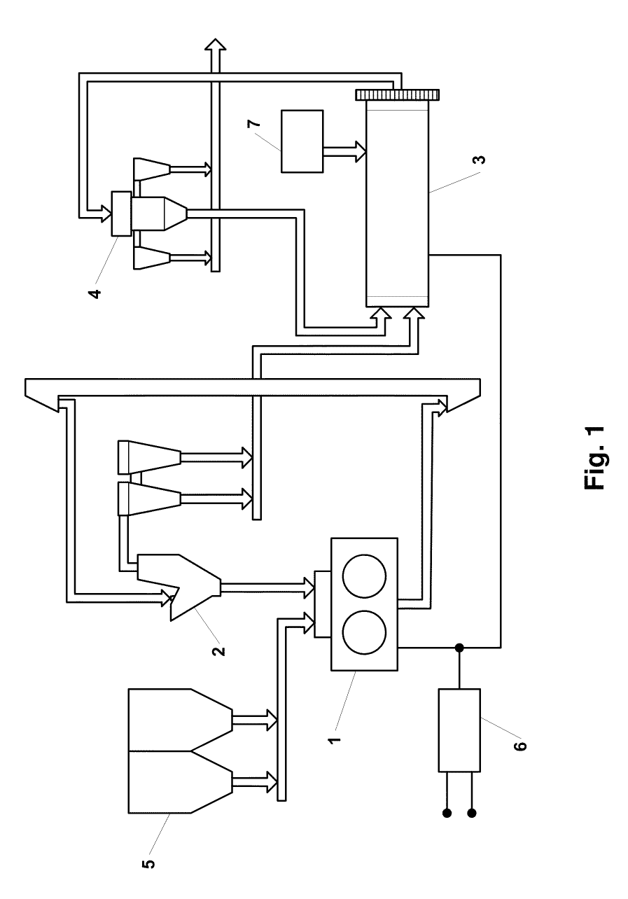

One of the embodiments is described schematically with the reference to the technological line for cement production that is shown on FIG. 1.

FIG. 1 shows receiving dozing bunkers 5 for the clinker and additives, static separator 2, device 6 for applying an electric potential, surfactant dozer 7, press roll mill 1, dynamic separator 4, ball mill 3, filters and pipelines.

The process of cement or cement additive production is performed in the following way: cement clinker and\or additive in fraction of 30-50 mm is fed from the dozing bunkers and the large size fraction is supplied via pipelines from separator 2 to the roller press mill 1, where these are pre-grinded until reaching the specific surface of 170-190 m²/kg. Then the clinker and/or supplement is fed to the separator 2 where it is separated into two fractions. The fine fraction with particles having the size up to 1000 μm is supplied to the ball mill 3. Large particles fraction (1000 μm and larger) is returned back to the mill 1 for the second processing. Then the grinding is carried out in the ball mill 3 to obtain particles having specific surface of 280-500 m²/kg.

In this Example in the grinding process the surfactant treatment is carried out prior to supplying the fine particles fraction to the ball mill. The consumption of the surfactant is regulated by a dozer 7 in amount that corresponds to the normative value (for Comparative Examples) or reduced amount (in accordance with the present invention) depending on the test mode as indicated in Claims and experimental Examples 1-6.

FIG. 6 further shows a device 6 for feeding the electric potential to the roller press mill and/or ball mill according to the invention. Any suitable device traditionally used for supplying voltage potential can be used in the present invention, such as, for example, described in RU 2100492.

The above method for producing cement or cement additive further provides reduction of specific power consumption to 35 kWh/per ton of cement or additive, increase of mill productivity by 10-20% of the original productivity. In this case the produced cement and additive have higher flow index, such as Pack Set Index.

The reduction in consumption of surfactants and improvement of milling ability of a clinker and/or additive results in reduction of the energy consumption costs also on a step of grinding in a ball mill and makes possible to diminish the mass of grinding bodies and the size thereof. The preliminary grinding in the roller press mill applying the electric potential to the shafts helps to diminish consumption of a surfactant that is supplied on the step of fine fraction grinding in the ball mill while maintaining or increasing the productivity.

The inventor of the present invention has further studied the effect of adding different traditionally used in the cement production industry additives for intensification of grinding processes according to the present invention. The comparative analysis has shown that the use of electric potential in combination with anion active surfactant according to the present invention is especially beneficial.

According to one embodiment, the process of grinding includes a grinding step in the roller press mill to obtain cement particles having specific surface of 190-220 m²/kg and the subsequent step of milling the cement clinker and/or the additive to obtain particles having specific surface of 280-500 m²/kg.

According to one example embodiment of the present invention, a ball mill with 3.2 m diameter and 15 m length can be used for grinding/milling. The assortment of the milling balls is the following: the 1-st chamber—balls having diameter D—70 mm, weight M—17 t; D—60 mm, weight M—18 t; D—50 mm and weight M—15 t; the 2-nd chamber: D—30 mm and weight M—80 t. The cement or the additive, obtained by the above method have the following grain composition, wt. %: 80 μm—5; 60 μm—20; 50 μm—20; 30 μm−50, 10 μm —5. The specific surface value of the cement obtained by the method of the invention is maintained or increased by 3-5%; the flow index is improved by 40-60% compared to the cement obtained by traditional methods. In such a case, the particles of the cement obtained have a more pronounced surface inhomogenuity, chips, roughness.

Thus, the present invention provides a method for reducing a surfactant consumption when grinding non-conductive materials, while maintaining or increasing the productivity of the grinding apparatuses and maintaining or increasing the milling quality, that lets substantially reduce the consumption of surfactant per unit of output production and increase the wear-resistance of grinding bodies that allows to lengthen the lifetime thereof, and thus, not only reduce direct costs of cement production by economies of surfactants, but also reduce overall production costs, such as energy consumption costs, maintenance, capital investment, etc and provide the environment friendly grinding process.

### EXAMPLES

### Example 1

Cement grinding using a combination of surfactant and electric potential in a mill having productivity of 100 t/h.

The experiment was carried out at the cement plant Aalborg Portland A/S, Denmark, using electric potential in combination with surfactants. The results of the experiments have demonstrated the positive effect of the present invention. Thus, for the mill having productivity of approximately 100 t/h, applying electric potential to the grinding bodies along with treating the material with surfactant (CBA® 1104, Grace) made it possible to decrease the consumption of surfactant from 440 l/h to 22 l/h while maintaining the same level of grinding quality. In terms of cost the sufficient economy can be achieved.

For example, if one liter of surfactant costs $0.8, then with the operation time of 6,000 h per year the economy is $105,000.000 with the same level of quality.

TABLE 1

| | | | Quality of milling, |
|---|---|---|---|
| Electric | Surfactant | | specific surface, |
| potential | consumption | Productivity | m²/kg |
| 105 V | 0 l/h | 107.8 t/h | 390 |
| 105 V | 22 l/h | 107.8 t/h | 417 |
| 105 V | 44 l/h | 107.4 t/h | 421 |

### Example 2

Cement grinding using a combination of surfactant and electric potential in combined grinding scheme with equipment productivity of 150-200 t/h.

The experiment was carried out at the cement plant Jungsin Cement Plant in Jungsin, South Korea. The grinding scheme corresponded to the combined grinding scheme presented on FIG. 1. The research showed that if the productivity of the mill is higher than 150 t/h, the use of two apparatuses for applying the electric potential to the grinding bodies, one for the roller press mill and another, for the ball mill, combined with treating the material with a surfactant (HEA2®) in the ball mill only reduced the surfactant consumption by 50% regarding the normative amount, while maintaining the grinding quality and increasing the productivity by 16% compared to the initial productivity with the use of 100% surfactant without applying the electric potential. Application of electric potential difference to the roller press only combined with the usage of a surfactant in amount of 100% of the normative amount results in the improvement of productivity by 14% and quality of milling improves by 3%. In terms of cost the method according to this embodiment can also provide the significant economy. For example, when the liter of surfactant costs $0.8, then with the operation time of 6,000 h per year the economy is $240,000.000 with 50% decrease of the surfactant consumption with the same level of quality.

TABLE 2

| | | |
|---|---|---|
| Use of a device | | |
| for applying the | | |
| electric potential | Surfactant | Specific |

| in the | in the | in the | Productivity, | surface, |
|---|---|---|---|---|
| roller press | mill | mill, % | t/h | m²/kg |
| − | − | 100 | 156 | 328 |
| + | − | 100 | 178 | 338 |
| + | + | 100 | 190 | 339 |
| + | + | 50 | 181 | 337 |
| + | + | 0 | 152 | 330 |

### Example 3

Cement grinding using a combination of surfactant and electric potential in one-step milling scheme with equipment productivity of 150-200 t/h.

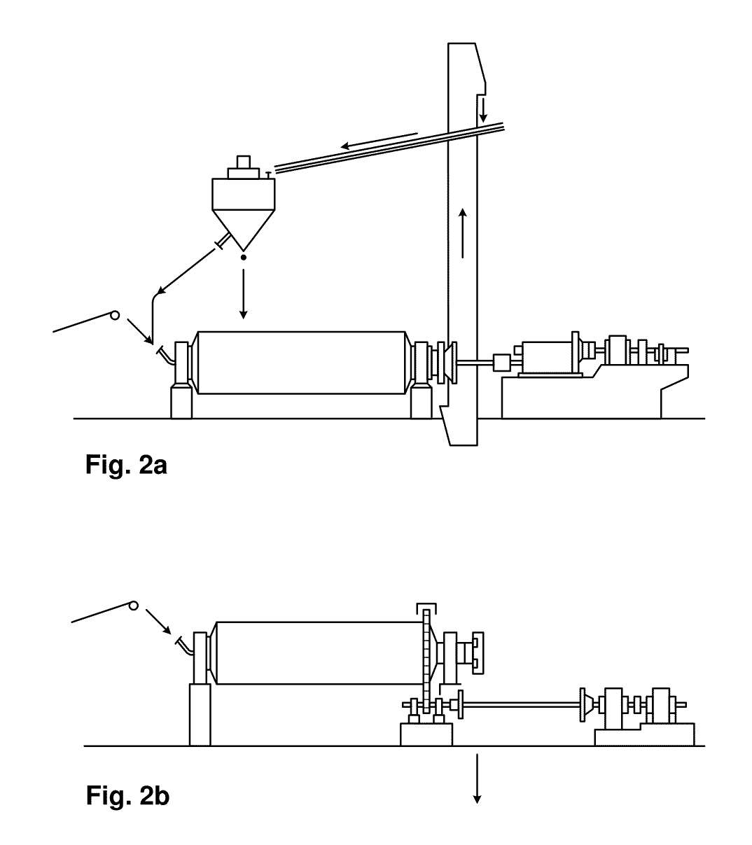

The experiment was carried out at the cement plant VICAT, Montalieu, France. The grinding scheme corresponded to the scheme of simple milling that is presented on FIG. 2. The studies of the mill with productivity of 110 t/h demonstrated that using an electric potential generator in combination with treating the material with surfactant when the normative level of surfactant is 100% (CRYSO®Cem Adm3) along with neutralizing the debris layer at the pre-surface layer of the grinding bodies by applying the generated electric potential to the grinding bodies increases the productivity by 10% regarding the initial productivity when 100% of the surfactant is used in the absence of electric potential. The milling quality was measured by laser granulometer and resulted in 50% of particles being less than 13.7 mkm in size, i.e. the quality was unchanged. In terms of cost the method according to the embodiment provides the significant economy. For example it will provide 66,000 extra tons of cement for 6,000 hours of work decreasing the energy consumption from 40 kWh/t to 36 kWh/t.

TABLE 3

| | | | |
|---|---|---|---|
| | | Production | Energy |
| Method | Productivity | per year, t | consumption |

| | | | |
|---|---|---|---|
| 100% of surfactant | 110 t/h | 660 000 | 40 kWh/t |
| combination of | 121 t/h | 726 000 | 36 kWh/t |
| 100% of surfactant and | | | |
| electric potential | | | |

### Example 4

Increase in the cement fluidity using a combination of a surfactant and electric potential in a mill and separator with the apparatus productivity up to 100 t/h.

The experiment was carried out at the cement production plant Ciment Quebec Inc., Saint Basile, QC, Canada. The grinding scheme was the same as the one that is shown on FIG. 2 (1), the scheme of the closed milling cycle with partial recycling of the large size particles. The tests demonstrated that in the mill with the productivity 90 t/h the consumption of the surfactant was 500 ml/t, and the flow index, Pack Set Index, measured according to ASTM 1565-09 was 15 that correspond to the normative value according to the existing methodology of this parameter measuring.

Using the apparatus for generating electric potential to apply the potential to grinding bodies in combination with the surfactant treatment at the normative amount of 500 ml/per ton of cement resulted in the Pack Set Index improvement by more than two times, i.e. it was decreased to 6 while the productivity was increased to 98 t/h.

TABLE 4

| Application of | | | | |
|---|---|---|---|---|
| electric potential | | Pack Set | Surfactant, | Productivity, |
| In the separator | In the mill | Index | ml/t | t/h |
| − | − | 15 | 500 | 90 |
| + | + | 6 | 500 | 98 |
| + | + | 8 | 280 | 96 |

The decrease of the surfactant consumption by 44% regarding the normative amount (down to 280 ml/t, i.e. to the level of surfactant consumption which corresponds to EU standards) while maintaining the same milling quality resulted in the increase of productivity by 6.6% and the improvement in flowability index by 46% in regard to the initial value. The economy can be estimated as $130 000 per year.

### Example 5

Improvement of the wear resistance of grinding bodies, neutralization of the debris-layer when using a combination of the surfactant and the electric potential both in the mill and in the separator with the productivity up to 100 t/h.

The experiment was carried out at the cement plant Vassiliko Cement Works in Cyprus. The grinding scheme was similar to the scheme of the closed milling cycle with partial recycling of the large size particles fraction shown in FIG. 2(1). The tests demonstrated (the results can be seen in Table 5) that in the mill with the productivity of 80 t/h when using a normative amount of 280 ml/t of the surfactant (triethanolamine), the wear rate of the grinding bodies HARDALLOY® was from 25 to 40 g/t at the energy consumption about 40 kWh/t. During the tests, electric potential of 70 V was applied to the grinding bodies in the ball mill. The results of the tests have shown that the application of the electric potential leads to neutralization of the debris-layer of the grinding bodies, and, hence, to elimination of electrostatic charge of the fresh cement produced by the ball mill.

Further, the inventor have performed additional research to investigate in more detail the structure of the debris-layer of grinding bodies and compare to the structure of debris layer of the grinding bodies used in a traditional milling process. According to the measurements made in the additional research, the electrostatic charge of cement at the output of the mill was 0 V, while in the absence of electric potential applied to the grinding bodies, the electrostatic charge of the cement at the output of the mill was +4 kV.

Advantageously, the supply of electric potential to the grinding bodies decreases the surfactant consumption to 255-260 ml/t that is about 7-9% economy of the normative amount. The wear rate of the grinding bodies used in the grinding process with combined application of electric potential and reduced consumption of the surfactant was about 9-13 g/t, i.e. it was improved by more than 60%, about 64-67%. In sum, the measures that were taken to improve the grinding process made possible to attain about 8-9% savings of the electric consumption from the normative amount that is about 39-40 kWh/t.

TABLE 5
Standard conditions/conditions according to the present invention

| | Consumption of | Wear of the | Specific |
|---|---|---|---|
| Mill | the surfactant | grinding | energy |
| productivity, | (triethanolamine), | bodies, | consumption, |
| t/h | ml/t | g/t | kWh/t |
| 82/90 | 280/255 | 40/13 | 40/36.5 |
| 67/73 | 280/260 | 25/9 | 39/35.5 |

### Example 6

The investigation of possibility for the realization of a method of the present invention in the grinding apparatus having the productivity of 25 t/h to exclude the consumption of surfactant, while its normative amount is 280 ml/t.

The investigation was carried out at the production plant SAS-Tobe Technologies in Sas-Tobe, Kazakhstan. The grinding scheme corresponded to the scheme shown in FIG. 2(1). Tests were carried out during milling of a cement of marks ShPTs 400 D30, PTs 400 D20 ( [symbol] 400 [symbol] 30, [symbol] 400 [symbol] 20). It was demonstrated in the tests that the use of a method of the present invention on the mill with productivity of 25 t/h with normative amount of surfactant (diethylene glycol)—280 ml/t with application of an electric potential of 110V to the grinding bodies in a ball mill allowed to neutralize the debris layer of the grinding bodies and completely exclude the use of liquid grinding intensifiers.

As the result, the use of a method according to the invention provides 100% exclusion of surfactant from the normative amount. The average milling fineness on the cement marks ShPTs D30 ( [symbol] 400 [symbol] 30) was 9% on the sieve 0.08, the specific surface was 3300 cm³/g. The average milling fineness on the mark PTs 400 D20 ( [symbol] 400 [symbol] 20) was 8.3%, the specific surface was 4001 cm³/g.

### Example 7

The studies of the possibility of neutralizing the debris-layer when applying electric potential and reducing the surfactant consumption to 0-20% when the productivity of the grinding equipment up to 60 t/h.

The tests were carried out at Raysut Cement Company (S.A.O.G) in Oman Sultanate (UAE). The grinding scheme corresponded to the scheme shown in FIG. 1. The tests were carried out while milling the cement with triethanolamine. As was demonstrated by the tests, the use of the method according to the invention in mill with productivity of 55.5 t/h using the normative amount of 280 ml/t of the surfactant (triethanolamine) made possible to eliminate the necessity of liquid intensifiers in the milling process when applying the electric potential of 100, 150, and 170 V to the grinding bodies. The elimination of surfactant makes the grinding method according to the invention environment friendly

TABLE 6

| Electric | Surfactant | | Specific |
|---|---|---|---|
| potential, | consumption, | Productivity, | surface, |
| V | l/h | t/h | m²/kg |
| N/A | 280 (100%) | 55 | 308 |
| 100 | 56 (20%) | 58 | 328 |
| 170 | 0 | 55 | 313 |

As can be seen in the Table 6, the use of a method according to the invention provides 100% reduction of surfactant. The average specific surface of the cement produced according to a traditional technique was 308 m²/kg, the consumption of the surfactant was normative and productivity 55.5 t/h. When using the method according to the present invention, and irrigating the cement with 20% of the normative amount of surfactant, the application of electric potential resulted in production of cement with specific surface 328 m²/g at the increased mill productivity 58 t/h. In the absence of surfactant, the application of electric potential resulted in the increase of specific surface to 313 at the same mill productivity of 55.5 t/h.

The studies of the structure of grinding bodies by x-ray and metallographic analysis showed that after extended period of use (for example after 100 h of work) in the presence of electric potential and with reduced amount of surfactant, the grinding bodies undergone stabilizing polygonization which occurs in pre-surface layers of the grinding bodies. In particular, deformations of sub-grained structure caused by mutual impingement of grinding bodies, resulted in strengthening the surface of the metal bodies, wherein the increased strength is maintained in the course of subsequent period of milling that significantly extends the lifetime of the grinding bodies. The results of the analysis testify the absence of the cell dislocation structure and the excess of margin dislocations of the same sign.

Hardening of grinding bodies leads to the improvement of wear-resistance and extended operating period of the equipment and, as result, provides substantial savings in electric consumption and the production operating costs.

We claim:

1. A method for grinding a non-conductive material, including at least one step of mechanical grinding the said material in a grinding apparatus with grinding bodies, having productivity of about 60 tons per hour and higher, wherein the method further includes a step of neutralizing a debris-layer formed in a pre-surface layer of the grinding bodies, by using in combination, in any order, simultaneously or sequentially, the following operations:
a) applying electric potential to the grinding bodies, in the said at least one grinding step, and
b) applying a surfactant to the said non-conductive material in the said at least one grinding step, wherein the amount of surfactant is from 50% to 100% of the normative amount.

2. The method according to claim 1, wherein the said non-conductive material is treated with a surfactant in amount selected from 50 to 60%, 60 to 70%, 70 to 80%, 80 to 90%, 50 to 100%, 60 to 100%, 70 to 100%, 80 to 100% of the normative amount.

3. The method according to claim 1, wherein the grinding apparatus is selected from rotating ball mill, vertical shaft mill, roller press mill.

4. The method according to claim 1, wherein the said method comprises a step of pre-grinding in a roller press mill followed by a step of milling in a rotating ball mill.

5. The method according to claim 1, wherein the said material comprises cement clinker and cement additives.

6. The method according to claim 1, wherein the applied electric potential is from 70 to 170V, preferably from 100 to 150V.

7. The method according to claim 1, wherein the surfactant comprises an anion-active substance.

8. The method according to claim 3, wherein the electric potential is applied to the surface of grinding shafts in the roller-press mill.

9. The method according to claim 3, wherein the electric potential is applied to the surface of grinding bodies in the ball mill.

10. The method according to claim 3, wherein the step of grinding in the roller-press mill is performed until specific surface of the said non-conductive material reaches from about 160 to about 250 m²/kg, preferably from about 190 to about 220 m²/kg.

11. The method according to claim 4, wherein the step of milling in a rotating ball mill is performed until specific surface of the said non-conductive material reaches from about 280 to about 500 m²/kg.

12. The method according to claim 1, wherein the grinding bodies are made of metal or metal alloys.

13. A cement or cement additive, produced by the method according to claim 1, characterized by the specific surface from about 280 to about 500 m2/kg and flow index improved by 40% compared with the normative.

14. A method for improvement of the grinding bodies wear resistance when grinding a non-conductive material in a mechanical mill having grinding bodies, wherein the method comprises a step of applying to the said non-conductive material a surfactant in amount of 50% to 100% of a normative amount, and a step of grinding with simultaneous application of electric potential to the grinding bodies, according to a method of claim 1.

15. A method for improvement of a flow index of a product produced by grinding a non-conductive material in a mechanical grinding apparatus having grinding bodies, wherein the method comprises a step of applying to the said non-conductive material a surfactant in amount of 50% to 100% of the normative amount, and a step of grinding with simultaneous application of electric potential to the grinding bodies, according to a method of claim 1.
